(19) United States
(12) Patent Application Publication
(10) Pub. No.: US 2025/0214646 A1
(43) Pub. Date: Jul. 3, 2025

(54) INDEPENDENT STEERING DEVICE HAVING A LINEAR ACTUATOR AND A VEHICLE INCLUDING THE SAME

(71) Applicants: HYUNDAI MOTOR COMPANY, Seoul (KR); KIA CORPORATION, Seoul (KR); SEOHAN INNOBILITY CO., LTD., Chungcheongbuk-do (KR)

(72) Inventors: Hyeong Seop Park, Hwaseong-si (KR); Min Sang Seong, Yongin-si (KR); Chang Seop An, Incheon (KR); Jin Ho Bae, Suwon-si (KR); Jae Geun Bang, Hwaseong-si (KR); Jung Min Cho, Hwaseong-si (KR); Seong Kweon Joo, Hwaseong-si (KR)

(73) Assignees: HYUNDAI MOTOR COMPANY, Seoul (KR); KIA CORPORATION, Seoul (KR); SEOHAN INNOBILITY CO., LTD., Chungcheongbuk-do (KR)

(21) Appl. No.: 18/742,850

(22) Filed: Jun. 13, 2024

(30) Foreign Application Priority Data
Dec. 29, 2023 (KR) 10-2023-0196580

(51) Int. Cl. B62D 5/04; B62D 7/18

(52) U.S. Cl. CPC B62D 5/0418; B62D 5/0445; B62D 7/18

(57) ABSTRACT

An independent steering device for a vehicle wheel includes: a knuckle provided with a first upper coupling portion and a second upper coupling portion at an upper portion and a lower coupling portion at a lower portion; a first actuator rotatably coupled to the first upper coupling portion; a second actuator positioned adjacent to the first actuator and rotatably coupled to the second upper coupling portion; and a lower connection member rotatably coupled to the lower coupling portion. The lower coupling portion may be positioned below a center of the knuckle between the first upper coupling portion and the second upper coupling portion.

### CROSS-REFERENCE TO RELATED APPLICATION(S)

This application claims the benefit of and priority to Korean Patent Application No. 10-2023-0196580 filed on Dec. 29, 2023, in the Korean Intellectual Property Office, the disclosure of which is incorporated herein by reference in its entirety.

### BACKGROUND

### 1. Field

The present disclosure relates to an independent steering device having a linear actuator and a vehicle including the same.

### 2. Description of Related Art

In general, a power steering system has a problem in that it has a complex configuration such as a pump, a gearbox that also serves as a power cylinder, and piping. These complexities make it difficult to precisely control steering assist force. Additionally, power steering may not operate when oil leaks. Moreover, any malfunctions in the operation of a steering device may lead to the dependent control of both left and right vehicle wheels, rendering vehicle steering control impossible or potentially dangerous.

### SUMMARY

To solve the aforementioned problems, a method of implementing independent steering for each vehicle wheel by applying an electric steering device using a motor to enable steering and precise control of the assist force with a simple configuration is provided.

An aspect of the present disclosure may provide an independent steering device capable of using all available strokes of a pair of linear actuators. Additionally, another aspect of the present disclosure may provide an independent steering device capable of improving steering performance by appropriately arranging a coupling point of the pair of linear actuators and a knuckle, and a coupling point of a lower arm and the knuckle. Additional aspects of the present disclosure include a vehicle with the aforementioned device and features.

According to an aspect of the present disclosure, an independent steering device may include: a knuckle provided with a first upper coupling portion and a second upper coupling portion at an upper portion and a lower coupling portion at a lower portion; a first actuator rotatably coupled to the first upper coupling portion; a second actuator positioned adjacent to the first actuator and rotatably coupled to the second upper coupling portion; and a lower connection member rotatably coupled to the lower coupling portion. The lower coupling portion may be positioned below a center of the knuckle between the first upper coupling portion and the second upper coupling portion.

The knuckle may be configured to be coupled to a vehicle wheel. The lower coupling portion may pass through the center of the knuckle between the first upper coupling portion and the second upper coupling portion and may be positioned at a rear side based on a virtual first plane, parallel to a rotational center shaft of the vehicle wheel.

The virtual first plane may bisect a distance between a virtual second plane that is parallel to the virtual first plane and passes through the first upper coupling portion and a virtual third plane that is parallel to the virtual first plane and passes through the second upper coupling portion.

The first actuator may be coupled to a first coupling point on the first upper coupling portion. The second actuator may be coupled to a second coupling point on the second upper coupling portion. The lower connection member may be coupled to a third coupling point on the lower coupling portion. The first coupling point may be positioned on the virtual second plane, the second coupling point may be positioned on the virtual third plane, and the third coupling point may be positioned between the virtual second plane and the virtual third plane.

The third coupling point may be positioned between the virtual first plane and the virtual third plane.

Another end portion of the first actuator and the other end portion of the second actuator may each be coupled to a vehicle body.

The independent steering device may further include an upper connection member connecting the second actuator and the vehicle body. The upper connection member may include a first fastening part coupled to at least a portion of the second actuator and a second fastening part extending from the first fastening part and coupled to the vehicle body.

The lower connection member may include a third fastening part coupled to the lower coupling portion and a fourth fastening part extending from the third fastening part and coupled to the vehicle body.

Each of the first actuator and the second actuator may include a stroke module provided to connect the knuckle and the vehicle body. The stroke module may include a piston coupled to the knuckle, a cylinder into which at least a portion of the piston is movably inserted, and a bracket which is coupled to the cylinder and coupled to the vehicle body. An inner surface of the cylinder may be provided with a guide groove in a longitudinal direction of the cylinder and an outer surface of the piston may be provided with a guide protrusion provided to be inserted into the guide groove.

Each of the first actuator and the second actuator may further include a driving module providing a driving force to linearly move the piston relative to the cylinder. The driving module may include a screw shaft that is rotatably disposed inside the cylinder, a screw nut that is fastened to the screw shaft to convert rotational motion of the screw shaft into linear motion of the piston, and a motor providing rotating force to the screw shaft.

The screw nut may be fixed to an inside of the piston.

Each of the piston and the screw nut may be provided with an insertion hole into which a fixing pin is inserted. A coupled position of the piston and the screw nut may be fixed by the fixing pin inserted into the insertion hole.

Each of the first actuator and the second actuator may further include a sensor that is coupled to the cylinder and provided to detect a relative position of the piston with respect to the cylinder. The sensor may be provided to detect the fixing pin.

An inner peripheral surface of the cylinder may be provided with an air flow groove for allowing air flow. The piston may be provided with an air flow hole for exhausting air flow.

The independent steering device may be positioned within a diameter of the vehicle wheel when viewing the vehicle wheel in a direction of the rotational center shaft.

According to another aspect of the present disclosure, a vehicle may include a vehicle body, a vehicle wheel mounted on the vehicle body, and a steering device connecting the vehicle body and the vehicle wheel and provided to steer the vehicle wheel. The steering device may include a knuckle coupled to the vehicle wheel and provided with a first upper coupling portion and a second upper coupling portion at an upper portion and a lower coupling portion at a lower portion. The steering device may also include a first actuator rotatably coupled to the first upper coupling portion and a second actuator positioned adjacent to the first actuator and rotatably coupled to the second upper coupling portion. The steering device may further include a lower connection member rotatably coupled to the lower coupling portion. The lower coupling portion may pass through a center of the knuckle between the first upper coupling portion and the second upper coupling portion and may be positioned at a rear side based on a virtual first plane, parallel to a rotational center shaft of the vehicle wheel.

### BRIEF DESCRIPTION OF DRAWINGS

The above and other aspects, features, and advantages of the present disclosure should be more clearly understood from the following detailed description taken in conjunction with the accompanying drawings, in which:

FIG. 1 is a perspective view illustrating a vehicle to which a steering device according to an embodiment in the present disclosure is applied;

FIG. 2 is a diagram illustrating a structure in which a steering device of a vehicle according to an embodiment in the present disclosure connects a body and a vehicle wheel;

FIG. 3 is a perspective view illustrating a structure in which a vehicle wheel, a steering device, and a body of a vehicle according to an embodiment in the present disclosure are connected;

FIG. 4 is a top plan view illustrating a structure in which a vehicle wheel, a steering device, and a body of the vehicle according to an embodiment in the present disclosure are connected;

FIG. 5 is a front view illustrating a structure in which a vehicle wheel, a steering device, and a body of the vehicle according to an embodiment in the present disclosure are connected;

FIG. 6 is a side view illustrating a structure in which a steering device and a body of a vehicle according to an embodiment in the present disclosure are connected;

FIG. 7 is a perspective view illustrating a state in which a second actuator and a first connection member of a steering device according to an embodiment in the present disclosure are coupled;

FIG. 8 is an exploded perspective view illustrating a state in which a first connection member is separated from a second actuator and in which the second actuator in FIG. 7 is disassembled;

FIG. 9 is a cross-sectional view illustrating a cross surface of the second actuator in FIG. 7 in one direction;

FIG. 10 is an enlarged perspective view of a portion of a cylinder of the second actuator in FIG. 7;

FIG. 11 is an enlarged perspective view of a portion of a piston of the second actuator in FIG. 7; and

FIG. 12 is a cross-sectional view illustrating an operation of changing a stroke of an actuator of a steering device according to an embodiment in the present disclosure.

### DETAILED DESCRIPTION

The present disclosure describes various embodiments, which may be variously modified. Therefore, specific embodiments of the present disclosure are illustrated in the accompanying drawings and described in detail. However, it should be understood that the present disclosure is not limited to a specific embodiments, but includes all modifications, equivalents, and substitutions without departing from the scope and spirit of the present disclosure.

Terms used in the specification such as “first,” “second,” and the like, may be used to describe various components, but the components are not to be interpreted as limited by the terms. The terms are used only to distinguish one component from another component. For example, a first component may be named a second component and the second component may also be similarly named the first component, without departing from the scope of the present disclosure. The term “and/or” includes a combination of a plurality of related described items or any one of the plurality of related described items.

Terms used in the present specification are used only in order to describe specific embodiments rather than limiting the present disclosure. Singular forms are intended to include plural forms unless the context clearly indicates otherwise. It should be further understood that the terms “comprises” or “have” and the like used in this specification specify the presence of stated features, steps, operations, components, parts mentioned in this specification, or a combination thereof. Such terms do not preclude the presence or addition of one or more other features, numerals, steps, operations, components, parts, or a combination thereof.

Unless indicated otherwise, it should be understood that all the terms used in the specification including technical and scientific terms have the same meaning as those that are generally understood by those having ordinary skill in the art. Terms generally used and defined by a dictionary should be interpreted as having the same or consistent meanings as those within a context of the related art. Such terms should not be interpreted as having ideal or excessively formal meanings unless being clearly defined otherwise in the present specification.

When a component, device, element, unit, member, or the like of the present disclosure is described as having a purpose or performing an operation, function, or the like, the component, device, element, member, or unit should be considered herein as being “configured to” meet that purpose or to perform that operation or function.

Hereinafter, embodiments of the present disclosure are described with reference to the drawings.

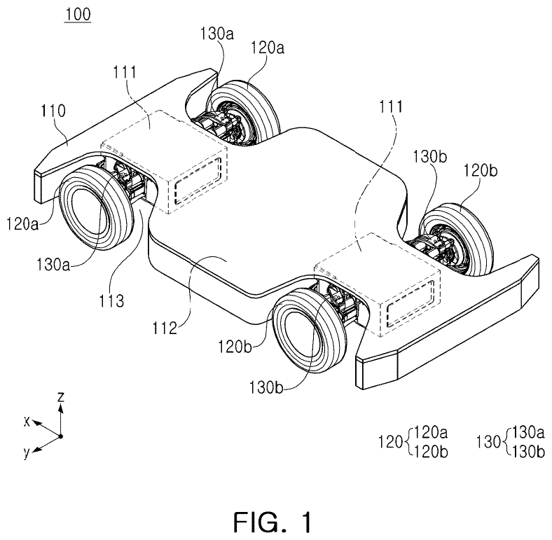

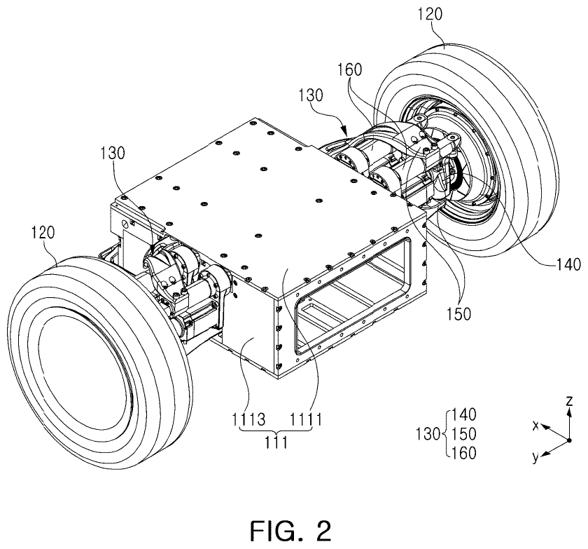

FIG. 1 is a perspective view illustrating a vehicle 100 to which a steering device 130 according to an embodiment in the present disclosure is applied. FIG. 2 is a diagram illustrating a structure in which the steering device 130 of the vehicle 100 according to the embodiment in the present disclosure connects a body 110 and a vehicle wheel 120.

FIG. 2 only illustrates a structure in which a pair of wheels (e.g., two front wheels 120a or two rear wheels 120b) among four wheels 120 illustrated in FIG. 1 is connected to the body 110 through the corresponding steering devices 130, respectively. However, the illustrated connection structure may be equally applied to the two front wheels 120a and the two rear wheels 120b.

The steering device 130 according to the embodiment in the present disclosure may be a vehicle steering device applied to the vehicle 100. The vehicle 100 refers to various vehicles that move objects such as people, animals, and objects from an origin to a destination. The vehicle is not limited to vehicles that run on roads or tracks.

The steering device 130 according to an embodiment may be provided in a structure in which it may be connected to a plurality of wheels 120 provided in the vehicle 100, respectively, to independently steer each vehicle wheel 120.

Referring to FIGS. 1 and 2, the vehicle 100 according to an embodiment may include the body 110, the vehicle wheel 120, and the steering device 130.

FIG. 1 schematically illustrates the vehicle 100 according to the embodiment. The vehicle 100 is not necessarily limited to having the structure illustrated or including only the components illustrated. Additionally, the vehicle 100 according to various embodiments may have a different structure or further include other components.

The body 110 may have a structure in which the vehicle wheel 120 and the steering device 130 are coupled and mounted. The body 110 may be moved by driving of the vehicle wheel 120 and adjusting the steering device 130 so its direction may be adjusted. The steering device 130 to which the vehicle wheel 120 is coupled may be coupled to at least a portion of the body 110, and thus, the vehicle wheel 120 may be mounted on the body 110.

The body 110 may include a chassis module 111 to which the connection member 150 is coupled. The chassis module 111 may form a portion of the body 110 or may be coupled to a base of the body 110. For example, it may be understood that FIG. 1 illustrates the vehicle 100 in a state in which the chassis module 111 illustrated in FIG. 2 is disposed inside the body 110 and the steering device 130 is coupled to the chassis module 111. In other words, an assembly in which the chassis module 111, the steering device 130, and the vehicle wheel 120 illustrated in FIG. 2 are coupled may be mounted on the vehicle 100 as the chassis module 111 is coupled to at least a portion of the inside of the body 110 illustrated in FIG. 1.

The steering device 130 may be coupled to the chassis module 111. A pair of steering devices 130 for connecting the pair of wheels 120 to the body 110 may be coupled to both sides of the chassis module 111. For example, two steering devices 130 may be coupled to both sides (e.g., side portions in a Y-axis direction) of the chassis module 111, and two wheels 120 may be coupled to the two steering devices 130, respectively.

The chassis module 111 may include a frame 1113 and a top plate 1111 coupled to the frame 1113. At least a portion of a first connection member 151 and an actuator 160 of the steering device 130 may be coupled between the frame 1113 and the top plate 1111. At least a portion of a second connection member 152 of the steering device 130 may be coupled to an outside and inside of the frame 1113.

The body 110 of the vehicle 100 illustrated in FIG. 1 may be referred to as a floor portion. The chassis module 111 of FIG. 2 may be installed below the floor and not exposed externally. For example, the chassis module 111 illustrated in FIG. 2 may be mounted on the floor by coupling the top plate 1111 to a lower surface of a base plate 112 of the floor, but the structure in which the chassis module 111 is mounted on the floor is not limited in any particular way.

According to various embodiments, the vehicle 100 may have an interior space installed on an upper portion of the body 110 (e.g., floor) illustrated in FIG. 1 where a user may board or cargo may be loaded. The interior space may include seats, the steering wheel, and the like.

The body 110 may be provided with a wheel house 113, which is a predetermined space where the vehicle wheel 120 and the steering device 130 are mounted. The wheel house 113 may be formed in a size that may secure a steering angle of the vehicle wheel 120 up to a specified angle. For example, the wheel house 113 is formed as a space having a size large enough to prevent the vehicle wheel 120 from contacting the body 110 when the vehicle wheel 120 rotates at the specified maximum steering angle.

According to the embodiment in the present disclosure, the space of the wheel house 113 may be used as the space in which the steering device 130 is disposed. As a result, the steering device 130 may be installed substantially parallel to the body 110 without protruding above the vehicle wheel 120.

The vehicle wheel 120 may be coupled to the steering device 130. The vehicle wheel 120 may be provided in plural numbers, and the steering device 130 may be provided to correspond to the plurality of wheels 120. For example, the plurality of wheels 120 may be coupled to the corresponding steering devices 130, respectively, and may rotate around a kingpin shaft (e.g., kingpin shaft 145) by the operation of the steering device 130.

The vehicle wheel 120 may be composed of four wheels, including two front wheels 120a and two rear wheels 120b. The front vehicle wheels 120a may be positioned on a front direction (hereinafter, front) side of the vehicle 100 and the rear vehicle wheels 120b may be positioned on a rear direction (hereinafter, rear) side of the vehicle 100. In FIGS. 1 and 2, a front (\textcircled{1}) of the vehicle 100 may be a direction parallel to a +X-axis direction, and a rear (\textcircled{2}) of the vehicle 100 may be a direction parallel to a −X-axis direction which is opposite to the front (\textcircled{1}). The two front wheels 120a may be connected to two front wheel steering devices 130a, respectively, and the two rear wheels 120b may be connected to two rear wheel steering devices 130b, respectively. As used herein, a wheel 120 may generally be referencing any one of the front or rear wheels 120a, 120b and a steering device 130 may generically be referencing any one of the first or second steering devices 130a, 130b.

The steering device 130 may connect the vehicle wheel 120 to the body 110. The steering device 130 may be provided to adjust a rotation angle of the vehicle wheel 120 according to a traveling direction of the vehicle 100 without being mechanically connected to the steering wheel. The steering device 130 may independently control the steering for each of the plurality of wheels 120. For example, the steering device 130 may operate to rotate the vehicle wheel 120 based on a steering signal input through the steering wheel (not illustrated).

According to the illustrated embodiment, the steering device 130 may be applied to the vehicle 100 provided with four wheels 120 and independently control the steering for the four wheels 120. However, the number of wheels 120 is not limited to four, and the steering device 130 may be applied to vehicles with less than four wheels 120 or vehicles with more than four wheels 120.

The steering device 130 may include the two front wheel steering devices 130a to which the two front wheels 120a are respectively connected and the two rear wheel steering devices 130b to which the two rear wheels 120b are respectively connected. According to the illustrated embodiment, the front wheel steering device 130a and the rear wheel steering device 130b may have the same structure. However, this is an example, and the front wheel steering device 130a and the rear wheel steering device 130b may have different structures. For example, based on FIG. 1, the front wheel steering device 130a may be changed to a device configured to rotate a knuckle 140 using a harmonic drive reducer and a motor with each axis arranged in parallel.

The steering device 130 may include the knuckle 140, the actuator 160, and a connection member 150. The steering device 130 may be provided in the form of an assembly in which an actuator 160 including a pair of actuators 160a and 160b and the connection member 150 are coupled to upper and lower ends of the knuckle 140. The steering device 130 may be mounted on the body 110 by coupling the actuator 160 and the connection member 150 to the chassis module 111.

The knuckle 140 is coupled to the vehicle wheel 120, and the connection member 150 and the actuator 160 connected to the knuckle 140 are respectively connected to the body 110 (i.e., chassis module 111), so the steering device 130 may connect the vehicle wheel 120 to the body 110.

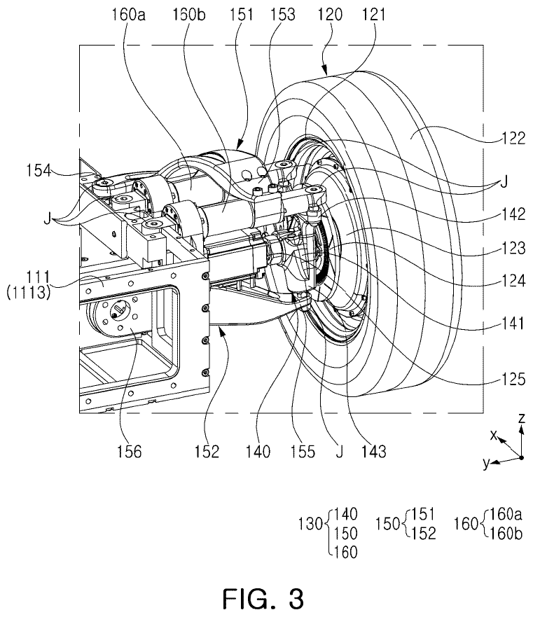

The structure in which the vehicle wheel 120 and the steering device 130 are connected to the body 110 and the components of the steering device 130 are described in more detail below with reference to FIGS. 3-6.

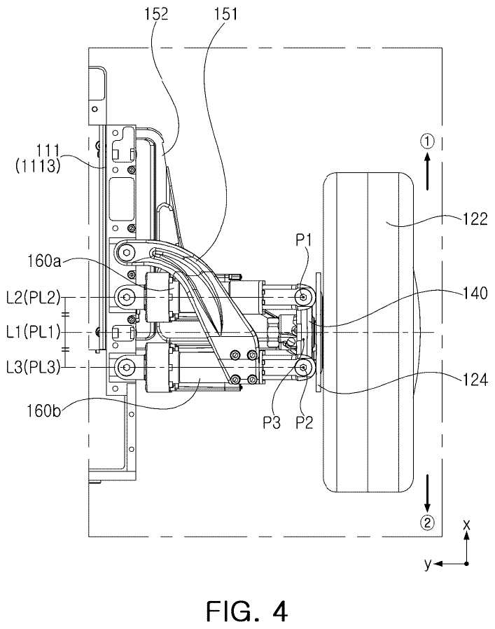

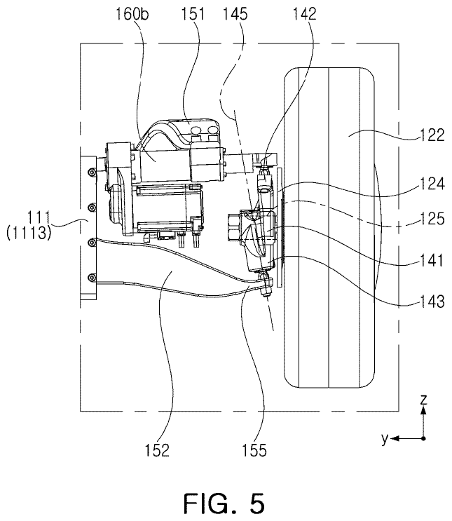

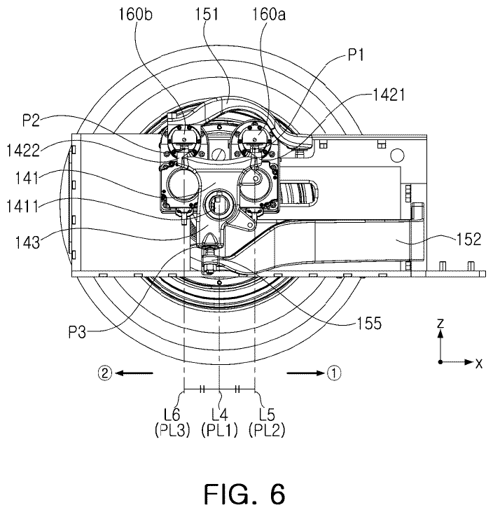

FIG. 3 is a perspective view illustrating the structure in which the vehicle wheel 120, the steering device 130, and the body 110 of the vehicle 100 according to the embodiment in the present disclosure are connected. FIG. 4 is a top plan view illustrating the structure in which the vehicle wheel 120, the steering device 130, and the body 110 of the vehicle 100 according to the embodiment in the present disclosure are connected. FIG. 5 is a front view illustrating the structure in which the vehicle wheel 120, the steering device 130, and the body 110 of the vehicle 100 according to the embodiment in the present disclosure are connected. FIG. 6 is a side view illustrating the structure in which the steering device 130 and the body 110 of the vehicle 100 according to the embodiment in the present disclosure are connected.

FIG. 3 is an enlarged view of a left part of FIG. 2. FIG. 4 is a view of the body 110, the steering device 130, and the vehicle wheel 120 illustrated in FIG. 3 viewed from above. FIG. 5 is a view of the body 110, the steering device 130, and the vehicle wheel 120 illustrated in FIG. 3 as viewed from the front on the rear (\textcircled{2}) side of the vehicle 100. FIG. 6 is a side view of the body 110 and the steering device 130 in a state in which the vehicle wheel 120 in FIG. 3 is separated from the knuckle 140.

For example, FIG. 4 is a plan view in an X-Y plane of the perspective view of FIG. 3. FIG. 5 is a front view in a y-z plane of the perspective view in FIG. 3. FIG. 6 is a side view in an x-z plane of the perspective view in FIG. 3.

Referring to FIGS. 3-6, the vehicle 100 according to the embodiment may include the chassis module 111 (e.g., body 110 in FIG. 1), the vehicle wheel 120, and the steering device 130.

The vehicle wheel 120 may be connected to the chassis module 111 through the steering device 130. For example, the vehicle wheel 120 may be coupled to the steering device 130, and the steering device 130 may be coupled to the chassis module 111.

An in-wheel motor driving method or an in-wheel system may be applied to the vehicle wheel 120. For example, the vehicle wheel 120 may be provided with the motor inside a wheel 121 to independently provide driving force to each of the plurality of vehicle wheels 120. The steering device 130 may also be provided on each of the plurality of wheels 120 to independently control the steering angles of the wheels 120, respectively.

According to the illustrated embodiment, the vehicle wheel 120 may include the wheel 121, a tire 122 disposed on an outside of the wheel 121, an in-wheel motor 123 disposed inside the wheel 121, and a brake disc 124 coupled to the in-wheel motor 123.

The in-wheel motor 123 is an electric motor mounted inside the wheel 121 to directly drive the wheel 121. The in-wheel motor 123 may be provided on each vehicle wheel 120 to independently drive and control the corresponding wheel 120. According to various embodiments, the in-wheel motor 123 may be referred to as a hub motor or an electric hub.

However, the illustrated embodiment is an example, and in the exemplary embodiment in the present disclosure, the vehicle wheel 120 is not limited to the form provided with the in-wheel motor 123. According to various embodiments, the steering device 130 may be configured to steer a general type of wheel to which the in-wheel system is not applied.

The vehicle wheel 120 may further include a wheel shaft 125 that is fixedly coupled to the knuckle 140 of the steering device 130 and is rotatably coupled to the in-wheel motor 123. The wheel shaft 125 may become a center of rotation of the wheel 121 and the tire 122 when the vehicle 100 is driven. For example, the in-wheel motor 123 may be rotatably fitted to the wheel shaft 125, and the knuckle 140 may be fitted to the wheel shaft 125. In other words, when the vehicle wheel 120 rotates to move the vehicle 100, the in-wheel motor 123, the wheel 121, the tire 122, and the brake disc 124 may rotate around the wheel shaft 125. The knuckle 140 and the wheel shaft 125 may be separated from the rotation of the in-wheel motor 123 and thus not rotate.

The steering device 130 may be disposed between the vehicle wheel 120 and the chassis module 111. The steering device 130 may be coupled to the vehicle wheel 120 and the chassis module 111, respectively, and connect the vehicle wheel 120 and the chassis module 111. The steering device 130 may independently drive the pair of linear actuators 160 to rotate the knuckle 140 around a kingpin shaft 145, thereby adjusting the steering angle of the vehicle wheel 120 coupled to the knuckle 140.

The steering device 130 may include the knuckle 140 that is coupled to the vehicle wheel 120, and the actuator 160 connecting the knuckle 140 and the chassis module 111. Additionally, the steering device 130 may include the connection member 150 connecting the knuckle 140 and the chassis module 111 and connecting the actuator 160 and the chassis module 111.

The actuator 160 is a linear actuator and may include a first actuator 160a and a second actuator 160b that form a pair. The first actuator 160a and the second actuator 160b may have the same configuration that is driven in the same manner.

The knuckle 140 may be coupled to the vehicle wheel 120 and may rotate around the kingpin shaft 145 together with the vehicle wheel 120. For example, the vehicle wheel 120 may rotate by the rotation of the knuckle 140. The knuckle 140 may form the kingpin shaft 145, which is a shaft around which the vehicle wheel 120 rotates. The knuckle 140 may be coupled to the wheel shaft 125 of the vehicle wheel 120.

The knuckle 140 may be coupled to the pair of actuators 160. The knuckle 140 may be rotatably coupled to each of the first actuator 160a and the second actuator 160b. For example, an upper portion of the knuckle 140 may be rotatably coupled to one end portion of the first actuator 160a and one end portion of the second actuator 160b through a ball joint J. The one end portion of the actuator 160 may be an end portion in a −Y-axis direction based on FIGS. 3-6, and the upper portion of the knuckle 140 may be an end portion in a +Z-axis direction based on FIGS. 3-6.

The knuckle 140 may be coupled to the second connection member 152 connected to the chassis module 111. The knuckle 140 may be rotatably coupled to the second connection member 152. For example, a lower portion of the knuckle 140 may be rotatably coupled to a third fastening part 155 of the second connection member 152 through the ball joint J. The lower portion of the knuckle 140 may be an end portion in a −Z-axis direction based on FIGS. 3-6.

Between the knuckle 140 and the second connection member 152 and between the knuckle 140 and the actuator 160, the knuckle 140 may be connected to enable relative rotation with respect to three axes (e.g., X-axis, Y-axis, and Z-axis) directions. The X-axis may correspond to a front-back direction (a longitudinal direction or lengthwise direction) of the vehicle 100, the Y-axis may correspond to a left-right direction (a latitudinal direction or widthwise direction) of the vehicle 100, and the Z-axis may correspond to an up-down direction (or height direction) of the vehicle 100.

The knuckle 140 may include a central coupling portion 141 to which the wheel shaft 125 of the vehicle wheel 120 is coupled and may include an upper coupling portion 142 that is positioned above the central coupling portion 141 and coupled to the actuator 160. The knuckle 140 may also include a lower coupling portion 143 that is positioned below the central coupling portion 141 and coupled to the second connecting member 152. For example, the upper coupling portion 142 may extend upward (e.g., +Z-axis direction) from the central coupling portion 141, and the lower coupling portion 143 may extend downward (e.g., −Z-axis direction) from the central coupling portion 141.

The central coupling portion 141 may have a through hole 1411 into which the wheel shaft 125 is inserted. As at least a portion of the wheel shaft 125 is inserted and fixed into the through hole 1411 of the central coupling portion 141, when the knuckle 140 rotates around the kingpin shaft 145, the vehicle wheel 120 may rotate together.

The upper coupling portion 142 may include a first upper coupling portion 1421 to which the first actuator 160a is rotatably coupled, and a second upper coupling portion 1422 to which the second actuator 160b is rotatably coupled. A piston 172 of the first actuator 160a may be rotatably coupled to the first upper coupling portion 1421 through the ball joint J, and the piston 172 of the second actuator 160b may be rotatably coupled to the second upper coupling portion 1422 through the ball joint J. The ball joint J may couple the actuator 160 to the upper coupling portion 142 so that the ball joint J may rotate around at least one of the X-axis, Y-axis, and Z-axis. For example, the first upper coupling portion 1421 and the second upper coupling portion 1422 may be provided with a fastening hole (not illustrated) to which the ball joint J is fastened.

The second connection member 152 may be rotatably coupled to the lower coupling portion 143. For example, the third fastening part 155 of the second connection member 152 may be rotatably coupled to the lower coupling portion 143 through the ball joint J. The ball joint J may couple the second connection member 152 to the lower coupling portion 143 so that the ball joint J may rotate around at least one of the X-axis, Y-axis, and Z-axis. For example, the lower coupling portion 143 may be provided with the fastening hole (not illustrated) to which the ball joint J is fastened.

The lower coupling portion 143 may be provided at a position where it deviates from the first upper coupling portion 1421 and the second upper coupling portion 1422. For example, as illustrated in FIG. 6, when the knuckle 140 is viewed from a side direction (e.g., latitudinal direction or Y-axis direction of the wheel shaft 125 which is a rotation center of the vehicle wheel 120), the lower coupling portion 143 may be provided at a position where the lower coupling portion 143 does not overlap the first upper coupling portion 1421 and the second upper coupling portion 1422 in the up-down direction. In other words, the lower coupling portion 143 is positioned between two extension lines L5 and L6 parallel to the Z-axis passing through the center of the ball joint J fastened to each of the first upper coupling portion 1421 and the second upper coupling portion 1422.

Referring to FIGS. 4 and 6, a first coupling point P1 where the first actuator 160a of the actuator 160 is coupled to the knuckle 140, a second coupling point P2 where the second actuator 160b of the actuator 160 is coupled to the knuckle 140, and a third coupling point P3 where the second connection member 152 is coupled to the knuckle 140 may be formed. For example, the first coupling point P1 may be a portion to which the ball joint J is fastened at the first upper coupling portion 1421 of the knuckle 140 or a center point of the corresponding part. The second coupling point P2 may be a portion to which the ball joint J is fastened at the second upper coupling portion 1422 of the knuckle 140 or a center point of the corresponding portion. The third coupling point P3 may be a part to which the ball joint J is fastened at the lower coupling portion 143 of the knuckle 140 or a center point of the corresponding portion.

As illustrated in FIGS. 4 and 6, a virtual first plane PL1 that is parallel to the y-z plane passing through the center of the first coupling point P1 and the y-z plane passing though the center of the second coupling point P2 is defined. A virtual second plane PL2 that is parallel to the virtual first plane PL1 while passing through the first coupling point P1 is defined. A virtual third plane PL3 that is parallel to the virtual first plane PL1 while passing through the third coupling point P3 is defined. The third coupling point P3 may be positioned between the virtual first plane PL1 and the virtual third plane PL3. The virtual first plane PL1 is a plane that bisects the virtual second plane PL2 and the virtual third plane PL3, and a distance between the virtual first plane PL1 and the virtual second plane PL2 is the same as a distance between the virtual first plane PL1 and the virtual third plane PL3.

The virtual first plane PL1, the virtual second plane PL2, and the virtual third plane PL3 may be perpendicular to the front (\textcircled{1}) and rear (\textcircled{2}) of the vehicle 100. FIG. 4 illustrates the X-Y plane, and some of the edges of the virtual planes PL1, PL2, and PL3 may be illustrated in the form of a straight line. In FIG. 4, a first straight line L1, a second straight line L2, and a third straight line L3 may be an edge in the Y-axis direction among the edges of each of the virtual first plane PL1, the virtual second plane PL2, and the virtual third plane PL3. In addition, FIG. 6 illustrates the x-z plane, and some of the edges of the virtual planes PL1, PL2, and PL3 may be illustrated in the form of a straight line. In FIG. 6, a fourth straight line L4, the fifth straight line L5, and the sixth straight line L6 may be an edge in the Z-axis direction among the edges of each of the virtual first plane PL1, the virtual second plane PL2, and the virtual third plane PL3.

For example, when the steering device 130 is viewed from above as illustrated in FIG. 4, the third coupling point P3 may be positioned between the second straight line L2 extending in a widthwise direction (e.g., Y-axis direction) of the chassis module 111 while passing through the first coupling point P1 and the third straight line L3 extending parallel to the second straight line L2 while passing through the second coupling point P2. However, the third coupling point P3 may be positioned on the rear (\textcircled{2}) side of the vehicle 100 based on the first straight line L1 that bisects a distance between the second straight line L2 and the third straight line L3. In other words, the third coupling point P3 may be positioned between the first straight line L1 and the third straight line L3. The widthwise direction of the chassis module 111 may be parallel to a rotational center shaft (e.g., wheel shaft 125) of the vehicle wheel 120.

For example, when the steering device 130 is viewed from the side as illustrated in FIG. 6, the third coupling point P3 may be positioned between the fifth straight line L5 extending in the height direction (e.g., Z-axis direction) of the chassis module 111 while passing through the first coupling point P1 and the sixth straight line L6 extending parallel to the fifth straight line L5 while passing through the second coupling point P2. More particularly, the third coupling point P3 may be positioned on the rear (\textcircled{2}) side of the vehicle 100 based on the fourth straight line L4 that bisects a distance between the fifth straight line L5 and the sixth straight line L6. In other words, the third coupling point P3 may be positioned between the fourth straight line L4 and the sixth straight line L6. The height direction of the chassis module 111 may be perpendicular to the widthwise direction of the chassis module 111 and perpendicular to the front (\textcircled{1}) and rear (\textcircled{2}) of the vehicle 100.

The knuckle 140, the first actuator 160a, the second actuator 160b, and the second connection member 152 of the steering device 130 according to the embodiment may be coupled in the form that the third coupling point P3 is positioned between the first coupling point P1 and the second coupling point P2. More particularly, the third coupling point P3 is positioned adjacent to the rear (\textcircled{2}) side of the vehicle 100 based on a center line of the first coupling point P1 and the second coupling point P2, so a maximum steering angle may be generated with a minimum length variation of the actuator 160 and the steering performance may be improved.

The connection member 150 may include the first connection member 151 connecting the second actuator 160b and the chassis module 111 and may include the second connection member 152 connecting the knuckle 140 and the chassis module 111. The first connection member 151 is configured to be connected to the upper portion of the knuckle 140 and may be referred to as an upper connection member. The second connection member 152 is configured to be connected to the lower portion of the knuckle 140 and may be referred to as a lower connection member. The illustrated embodiment is an example, and the first connection member 151 may be omitted according to various embodiments.

The first connection member 151 may connect the chassis module 111 and the second actuator 160b at an upper portion of the actuator 160b. The first connection member 151 may include a first fastening part 153 that is coupled to the second actuator 160b and a second fastening part 154 that extends from the first fastening part 153 and is coupled to the chassis module 111.

The first fastening part 153 may be fixedly coupled to at least a portion of the second actuator 160b. The second fastening part 154 may be rotatably coupled to the chassis module 111. The second fastening part 154 may be rotatably coupled to the frame 1113 of the chassis module 111 through the ball joint J.

The first connection member 151 may connect the second actuator 160b and the chassis module 111 in the form that a middle portion between the first fastening part 153 and the second fastening part 154 extends across the first actuator 160a to partially overlap the first actuator 160a.

The second connection member 152 may connect the chassis module 111 and the knuckle 140 below the actuator 160. The second connection member 152 may rotate in response to a change in stroke of the actuator 160. The second connection member 152 may include the third fastening part 155 that is coupled to the lower coupling portion 143 and may include the fourth fastening part 156 that extends from the third fastening part 155 and is coupled to the chassis module 111.

The third fastening part 155 may be rotatably coupled to the knuckle 140. The third fastening part 155 may be rotatably coupled to the knuckle 140 through the ball joint J. For example, the knuckle 140 may rotate around the kingpin shaft 145 with respect to the third fastening part 155. The fourth fastening part 156 may be rotatably coupled to the inside of the frame 1113 of the chassis module 111.

According to various embodiments, the vehicle 100 may be configured to increase or decrease the height of the vehicle 100 by rotating the fourth fastening part 156 around the X-axis. For example, when the fourth fastening part 156 rotates clockwise around the X-axis based on FIG. 3, a height of the body 110 increases with respect to the vehicle wheel 120. When the fourth fastening part 156 rotates counterclockwise around the X-axis, the height of the body 110 decreases with respect to the vehicle wheel 120. For such height adjustment, one end portion of the actuator 160 and the third fastening part 155 of the second connection member 152 may be rotatably coupled to the knuckle 140 around the X-axis. The other end portion of the actuator 160 and the second fastening part 154 of the first connection member 151 may be rotatably coupled to the frame 1113 around the X-axis.

The actuator 160 may include the first actuator 160a whose one end portion is coupled to the first upper coupling portion 1421 of the knuckle 140 and other end portion is coupled to the chassis module 111. The actuator 160 may also include the second actuator 160b whose one end portion is coupled to the second upper coupling portion 1422 of the knuckle 140 and other end portion is coupled to the chassis module 111. The first actuator 160a may be positioned in front (\textcircled{1}) of the second actuator 160b.

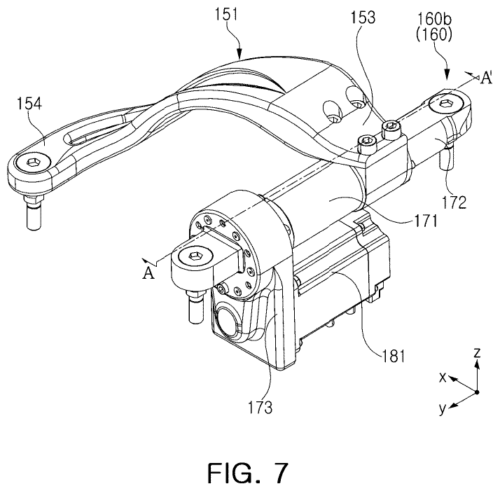

The description of FIGS. 3-6 focuses on the coupling structure between the actuator 160 and the knuckle 140 and between the actuator 160 and the chassis module 111. The configuration of the actuator 160 is described in more detail below with reference to FIGS. 7-11.

Both end portions of the first actuator 160a may be rotatably coupled to the first upper coupling portion 1421 of the knuckle 140 and the frame 1113 of the chassis module 111, respectively. Both end portions of the second actuator 160b may be rotatably coupled to the second upper coupling portion 1422 of the knuckle 140 and the frame 1113 of the chassis module 111, respectively. For example, the first actuator 160a and the second actuator 160b may be rotatably coupled to the first upper coupling portion 1421, the second upper coupling portion 1422, and the frame 1113 through a ball joint J.

One end portion of the first actuator 160a and one end portion of the second actuator 160b may be rotatably coupled to the first upper coupling portion 1421 and the second upper coupling portion 1422, respectively, around at least the X-axis and Z-axis. The other end portion of the first actuator 160a may be rotatably coupled to the frame 1113 around at least the X-axis and the Z-axis. The other end portion of the second actuator 160b may be coupled to the frame 1113 so as to be rotatable around the X-axis but may restrictively rotate around the Z-axis. For example, the rotation of the other end portion of the second actuator 160b around the Z-axis may be restricted by a locking protrusion (not illustrated) of the frame 1113.

However, a freedom of rotation or constraint conditions between the first and second actuators 160a and 160b and the knuckle 140, between the first actuator 160a and the chassis module 111, and between the second actuator 160b and the chassis module 111 are not limited to the above-described contents and may be changed according to various embodiments. For example, both the end portions of both the first actuator 160a and the second actuator 160b may be rotatably coupled to the knuckle 140 and the chassis module 111 around the X-axis, Y-axis, and Z-axis, respectively.

The steering device 130 may connect and support the vehicle wheel 120 and the chassis module 111 through the pair of actuators 160 that is coupled to the upper portion of the knuckle 140 and the second connection member 152 that is coupled to the lower portion of the knuckle 140. As a result, the steering device 130 provides a double wishbone type suspension structure. For example, the first actuator 160a may be referred to as an upper link, the second actuator 160b (or second actuator 160b to which the first connection member 151 is coupled) may be referred to as an upper arm, and the second connection member 152 may be referred to as a lower arm.

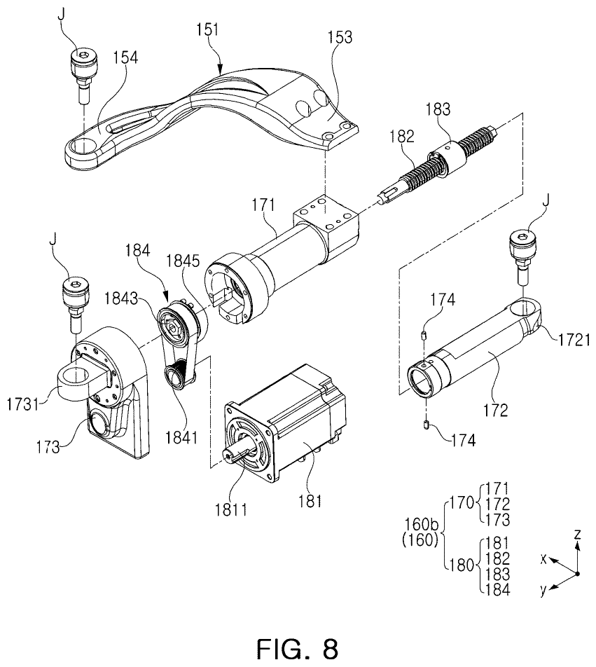

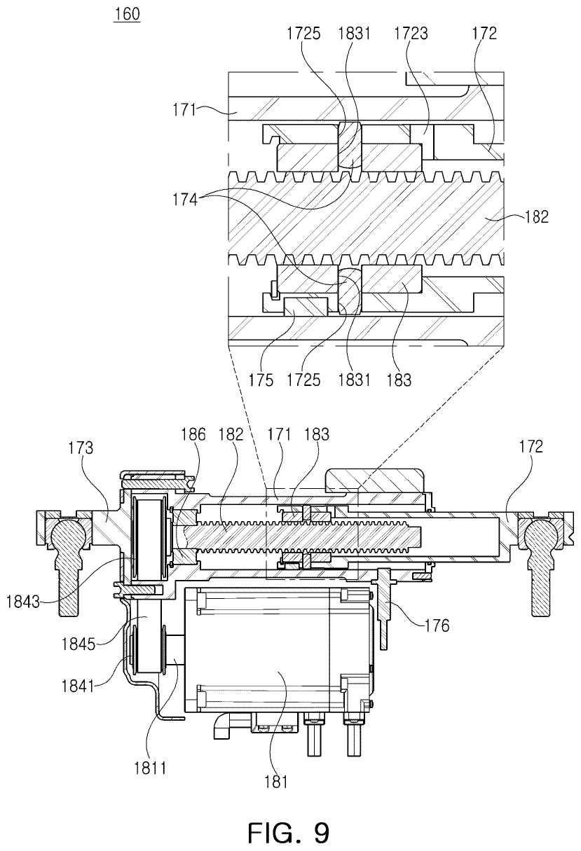

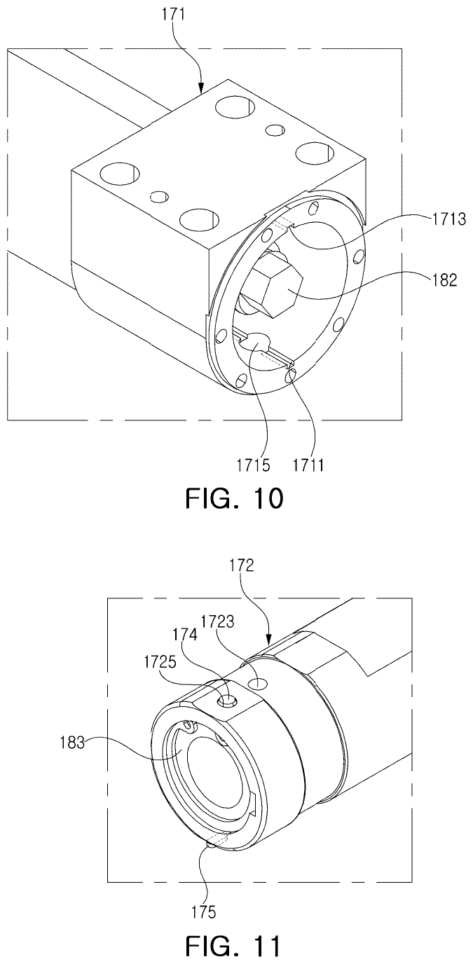

FIG. 7 is a perspective view illustrating a state in which the second actuator 160b and the first connection member 151 of the steering device 130 according to the embodiment of the present disclosure are coupled. FIG. 8 is an exploded perspective view illustrating a state in which the first connection member 151 is separated from the second actuator 160b and the second actuator 160b is disassembled in FIG. 7. FIG. 9 is a cross-sectional view illustrating a cross-section in one direction of the second actuator 160b in FIG. 7. FIG. 10 is an enlarged perspective view of a portion of a cylinder 171 of the second actuator 160b in FIG. 7. FIG. 11 is an enlarged perspective view of a portion of the piston 172 of the second actuator 160b in FIG. 7.

FIG. 9 illustrates a cross-section in the A-A′ direction of the second actuator 160b illustrated in FIG. 7.

Since FIGS. 7 and 8 illustrate the second actuator 160b to which the first connection member 151 is coupled, the components of the actuator 160 are described below based on the second actuator 160b. However, the components included in the first actuator 160a and the second actuator 160b, respectively, are the same, and differ only in a position where the first actuator 160a and the second actuator 160b are coupled to the knuckle 140 and whether or not the first actuator 160a and the second actuator 160b are coupled to the first connection member 151. As a result, the components of the second actuator 160b described below may be equally applied and provided to the first actuator 160a.

FIGS. 7-11 are diagrams illustrating in detail the first connection member 151, the second actuator 160b, and the components of the second actuator 160b illustrated in FIGS. 2-6. Hereinafter, in describing FIGS. 7-11, FIGS. 2-6 are also referred to.

Referring to FIGS. 7-11, the steering device 130 according to the embodiment may include the second actuator 160b and the first connection member 151 that is coupled to the second actuator 160b.

The first connection member 151 may include the first fastening part 153 that is fixed to a portion of the cylinder 171 of the second actuator 160b and the second fastening part 154 that extends from the first fastening part 153 and is rotatably coupled to the chassis module 111 through the ball joint J. However, as described above, according to various embodiments, the steering device 130 may not include the first connection member 151.

The second actuator 160b (or first actuator 160a) may include a stroke module 170 connecting the knuckle 140 and the chassis module 111. The stroke module 170 is provided to increase or decrease the stroke and a driving module 180 provides driving force to increase or decrease the stroke of the stroke module 170.

The stroke module 170 may include the cylinder 171, the piston 172, and a bracket 173. The driving module 180 may include a motor 181, a screw shaft 182, a screw nut 183, and a power transmission member 184. For example, the driving module 180 may be provided to increase or decrease the stroke of the stroke module 170 by providing the driving force to linearly move the piston 172 relative to the cylinder 171.

The stroke module 170 may have a structure in which a knuckle joint part 1721 of the piston 172 is coupled to an upper coupling portion (e.g., first coupling point P1 or second coupling point P2) of the knuckle 140 and in which a body joint part 1731 of the bracket 173 is coupled to the chassis module 111. One end portion of the cylinder 171 is coupled to the bracket 173 and at least a portion of the piston 172 is movably coupled to an inside of the cylinder 171 on the other end portion of the cylinder 171. For example, the cylinder 171 may be coupled to an outside of the piston 172 so that the piston 172 can move with respect to the cylinder 171. The piston 172 may reciprocate linearly within the cylinder 171 so that the stroke of the stroke module 170 increases (or the length increases) or decreases (or the length decreases).

In the stroke module 170, the knuckle joint part 1721 of the piston 172 may be coupled to the upper coupling portion 142 so as to be rotatable around at least the X-axis and the Z-axis. Additionally, the body joint part 1731 of the bracket 173 may be coupled to the chassis module 111 so as to be rotatable at least around the X-axis.

For example, the rotation of the piston 172 around the X-axis in the upper coupling portion 142 may be a relative rotation corresponding to the operation of adjusting a camber or the height of the vehicle wheel 120 on the knuckle 140. The rotation of the piston 172 around the Z-axis may be a relative rotation corresponding to the rotation to adjust the steering angle of the vehicle wheel 120 on the knuckle 140. In addition, the rotation of the bracket 173 around the X-axis in the chassis module 111 may be a relative rotation corresponding to the operation of adjusting the height of the vehicle wheel 120 or the operation of absorbing shock.

The driving module 180 may include the motor 181 providing rotating force, the screw shaft 182 that rotates by receiving the rotating force of the motor 181, and the screw nut 183 that is coupled to the screw shaft 182 to convert rotational motion into linear motion. The driving module may also include the power transmission member 184 that transmits the rotating force of the motor 181 to the screw shaft 182.

The motor 181 may provide driving force for the rotation of the screw shaft 182. The motor 181 may be a servomotor but is not limited thereto. The motor 181 may be coupled to the bracket 173.

The screw shaft 182 may be rotatably coupled to the inside of the cylinder 171 and an outer peripheral surface thereof may be formed with a screw thread. The screw shaft 182 may be arranged parallel to a rotating shaft of the motor 181. For example, the screw shaft 182 may be rotatably coupled inside the cylinder 171 through a bearing 186. Rotational motion of the screw shaft 182 with respect to the cylinder 171 may be possible, but a linear movement of the screw shaft 182 with respect to the cylinder 171 may be restricted. In other words, the screw shaft 182 may rotate while its position is fixed with respect to the cylinder 171 so that the screw shaft 182 serves as a reference for the screw nut 183 to move linearly.

The screw nut 183 may be fixedly disposed inside the piston 172 and may have screw threads formed on its inner peripheral surface that engage with the screw threads of the screw shaft 182. The screw nut 183 may be fixed to the piston 172 when the screw shaft 182 rotates and may be separated from the rotation of the screw shaft 182. Thus, the screw nut 183 may move along the screw shaft 182 in the left-right direction (e.g., the length direction of the screw shaft 182 or Y-axis direction).

The power transmission member 184 may be connected to a rotating shaft 1811 of the motor 181 and the screw shaft 182. The power transmission member 184 may transmit the rotational motion of the rotating shaft 1811 of the motor 181 to the screw shaft 182 to rotate the screw shaft 182.

The power transmission member 184 may include a first pulley 1841 that is coupled to the rotating shaft 1811 of the motor 18; a second pulley 1843 that is coupled to the screw shaft 182, and a belt 1845 connecting the first pulley 1841 and the second pulley 1843. For example, when the first pulley 1841 may rotate by the rotation of the rotating shaft 1811, the rotation of the first pulley 1841 may be transmitted to the second pulley 1843 through the belt 1845. As a result, the screw shaft 182 may rotate by the rotation of the second pulley 1843. The power transmission member 184 may provide deceleration while transmitting the power of the rotational motion. The first pulley 1841 and the second pulley 1843 may have different diameters depending on a speed ratio.

At least a portion of the power transmission member 184 may be disposed inside the bracket 173. For example, the first pulley 1841 may be disposed in a space between the motor 181 and the bracket 173 and the second pulley 1843 may be disposed in a space between the cylinder 171 and the bracket 173. The belt 1845 may connect the first pulley 1841 and the second pulley 1843 while partially surrounding the outer peripheral surfaces of the first pulley 1841 and the second pulley 1843. The second pulley 1843 may be at least partially disposed inside the cylinder 171.

Hereinafter, components are described for preventing the rotation of the piston 172 with respect to the cylinder 171 in order to convert the rotational motion of the screw shaft 182 into the linear movement of the screw nut 183 and for fixing the screw nut 183 inside the piston 172.

The cylinder 171 may be formed in a hollow cylindrical shape into which the piston 172 is inserted. A guide protrusion 175 may be provided on an outer peripheral surface of the piston 172 and a guide groove 1711 into which the guide protrusion 175 is inserted may be provided on an inner peripheral surface of the cylinder 171. The guide groove 1711 may extend along a longitudinal direction of the cylinder 171 and the guide protrusion 175 may be inserted into the guide groove 1711 to be slidable along the guide groove 1711. Accordingly, the linear movement of the piston 172 with respect to the cylinder 171 may be guided while the rotation of the piston 172 with respect to the cylinder 171 is prevented.

The piston 172 may be formed in a hollow cylindrical shape into which the screw nut 183 is inserted. The piston 172 may be provided with an insertion hole 1725 into which a fixing pin 174 is inserted, and the screw nut 183 may be provided with an insertion hole 1831 into which a fixing pin 174 is inserted. The coupled position of the piston 172 and the screw nut 183 may be fixed by inserting the fixing pin 174 after the insertion holes 1725, 1831 are aligned. In other words, the rotation and movement of the screw nut 183 and the piston 172 with respect to the cylinder 171 may be prevented by inserting the fixing pin 174 into the insertion hole 1725, 1831.

The configurations for preventing the rotation of the piston 172 with respect to the cylinder 171 and for fixing the screw nut 183 inside the piston 172 are not limited to the above-described contents and may be changed into various configurations.

The cylinder 171 and the piston 172 may have an air flow passage so that air can flow in response to a change in volume inside the cylinder 171 and the piston 172 when the piston 172 moves with respect to the cylinder 171. The cylinder 171 may be formed with an air flow groove 1713 formed on the inner peripheral surface thereof. The piston 172 may be formed with an air flow hole 1723 penetrating from the outer peripheral surface to the inner peripheral surface. When the piston 172 moves, the air inside the cylinder 171 may be exhausted through the air flow groove 1713, and the air inside the piston 172 may be exhausted through the air flow hole 1723.

According to the embodiment illustrated in FIGS. 10 and 11, the air flow groove 1713 may be formed at a portion facing the guide groove 1711 on the inner peripheral surface of the cylinder 171. The air flow groove 1713 may be formed in a portion aligned with the fixing pin 174 in the longitudinal direction in the piston 172. However, this is merely an example. The positions of the air flow groove 1713 and the air flow hole 1723 may not be limited to the shapes illustrated in FIGS. 10 and 11 and may be disposed in various positions within the range that may detect the fixing pin 174.

The actuator 160 may be provided with a sensor 176 that detects the position of the piston 172 to detect the stroke distance of the stroke module 170. The sensor 176 may be coupled to the cylinder 171 and may detect the position and distance of the fixing pin 174 inserted into the piston 172. For example, the sensor 176 may include a proximity sensor, but the type of sensor 176 is not particularly limited. According to various embodiments, the actuator 160 may not include the sensor 176.

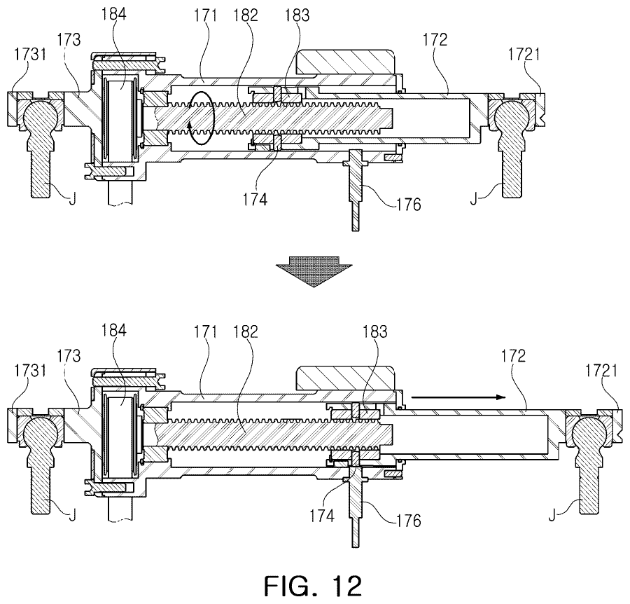

The sensor 176 may be coupled to the cylinder 171 so as to penetrate through at least a portion of the cylinder 171. When the piston 172 moves inside the cylinder 171 and reaches a predetermined position, the piston 172 may partially face the fixing pin 174 (e.g., see FIG. 12). A sensor coupling hole 1715 to which the sensor 176 is coupled may be formed in the cylinder 171.

According to the embodiment illustrated in FIG. 10, the sensor coupling hole 1715 may be formed at a position overlapping with the guide groove 1711 and connected to the guide groove 1711. However, this is an example, and a position of the sensor coupling hole 1715 is not limited to the shape illustrated in FIG. 10. Additionally, the sensor coupling hole 1715 may be disposed in various positions within a range that may detect the fixing pin 174.

FIG. 12 is a cross-sectional view illustrating the operation of changing the stroke of the actuator 160 of the steering device 130 according to the embodiment in the present disclosure.

FIG. 12 is a diagram illustrating the operation of the actuator 160 increasing from a minimum stroke to a maximum stroke.

In describing FIG. 12, FIGS. 2-6 may be referenced as illustrating the structure in which the steering device 130 is connected to the vehicle wheel 120 and the body 110. Additionally, FIGS. 7-9 may also be referenced as illustrating a detailed configuration of the actuator 160.

The actuator 160 may operate so that the piston 172 reciprocates linearly with respect to the cylinder 171 and the bracket 173. This is achieved by rotating the screw shaft 182 through the driving of the motor 181 and moving the screw nut 183 on the screw shaft 182 due to the rotation of the screw shaft 182. The stroke of the actuator 160 may increase or decrease according to the linear motion of the cylinder 171.

The actuator 160 may be configured so that the sensor 176 and the fixing pin 174 are aligned when the actuator 160 increases to its maximum stroke.

The steering device 130 may adjust the steering angle of the vehicle wheel 120 by rotating the knuckle 140 according to the strokes of the first actuator 160a and the second actuator 160b. For example, the steering device 130 may rotate the vehicle wheel 120 around the kingpin shaft 145 by operating the first actuator 160a and the second actuator 160b with different strokes.

For example, as illustrated in FIGS. 3-6, when the first actuator 160a and the second actuator 160b are in a neutral state maintaining the same stroke (or length), the vehicle 100 may drive straight in the forward and backward directions (\textcircled{1}, \textcircled{2}). When the stroke of the first actuator 160a decreases (e.g., operates in the direction opposite to the arrow in FIG. 12) and the stroke of the second actuator 160b increases (e.g., operates in the direction of the arrow in FIG. 12) based on the neutral state, the vehicle wheel 120 may be steered so that the vehicle 100 turns left. Conversely, when the stroke of the first actuator 160a increases and the stroke of the second actuator 160b decreases based on the neutral state, the vehicle wheel 120 may be steered so that the vehicle 100 turns right.

The description related to the operation of the actuator 160 is based on the steering device 130 and the vehicle wheel 120 disposed on the right side of the front (\textcircled{1}) of the vehicle 100 with reference to FIGS. 3-6. Since the steering device 130 corresponding to the pair of front wheels 120a or the pair of rear wheels 120b is arranged symmetrically with respect to the chassis module 111, the operations of the steering device 130 and the vehicle wheel 120 disposed on the left may be opposite. In other words, the vehicle wheel 120 disposed on the left may be steered to turn right when the stroke of the first actuator 160a decreases and the stroke of the second actuator 160b increases. Additionally, the vehicle wheel 120 may be steered to turn left when the stroke of the first actuator 160a increases and the stroke of the second actuator 160b decreases.

As described above, in an embodiment, the first actuator 160a (e.g., body joint part 1731 of the bracket 173) is rotatable around the X-axis and Z-axis with respect to the body 110. Additionally, the second actuator 160b (e.g., body joint part 1731 of the bracket 173) is rotatable around the X-axis with respect to the body 110, but the rotation of the second actuator 160b around the Z-axis may be limited. In addition, the first actuator 160a and the second actuator 160b (e.g., the knuckle joint part 1721 of the piston 172) may be rotatable around the X-axis and Z-axis with respect to the knuckle 140.

In the above embodiment, rotation of the body joint part 1731 and the knuckle joint part 1721 around the X-axis may correspond to the height adjustment operation. Additionally, the rotation of the knuckle joint part 1721 around the Z-axis and the rotation of the body joint part 1731 of the first actuator 160a around the Z-axis may correspond to the steering angle adjustment operation.

In the above embodiment, when the vehicle 100 turns left, when the stroke distance of the first actuator 160a is smaller than the stroke distance of the second actuator 160b, the first actuator 160a rotates around the Z-axis to correspond to the distance that the first coupling point P1 moves in the X-axis direction in the state in which the rotation of the second actuator 160b around the Z-axis is prevented.

Conversely, in the above embodiment, when the vehicle 100 turns right, when the stroke distance of the first actuator 160a is larger than the stroke distance of the second actuator 160b, the first actuator 160a rotates around the Z-axis to correspond to the distance that the first coupling point P1 moves in the X-axis direction in the state in which the rotation of the second actuator 160b around the Z-axis is prevented.

However, the freedom of rotation of the first actuator 160a and the second actuator 160b with respect to the body 110 is not limited to the above embodiment. According to various embodiments, both the first actuator 160a and the second actuator 160b may be provided to be rotatable around the X-axis and Z-axis with respect to the body 110.

According to the embodiment in the present disclosure, by optimally designing the coupling point of the pair of linear actuators and the knuckle and the coupling point of the lower arm and the knuckle, it is possible to use all the available strokes of the linear actuators and generate the maximum steering angle with the minimum length variation.

In addition, according to the embodiment in the present disclosure, by allowing the pair of linear actuators to perform the function of the arm structure, it is possible to use the linear actuator as the suspension element.

While embodiments have been illustrated and described above, it should be apparent to those having ordinary skill in the art that modifications and variations could be made without departing from the scope of the present disclosure as defined by the appended claims.

In addition, embodiments of the present disclosure may be implemented with some components having been omitted. The components of each embodiment may also be configured in combination with each other.

What is claimed is:

1. An independent steering device, comprising:
a knuckle provided with a first upper coupling portion and a second upper coupling portion at an upper portion and a lower coupling portion at a lower portion;
a first actuator rotatably coupled to the first upper coupling portion;
a second actuator positioned adjacent to the first actuator and rotatably coupled to the second upper coupling portion; and
a lower connection member rotatably coupled to the lower coupling portion,
wherein the lower coupling portion is positioned below a center of the knuckle between the first upper coupling portion and the second upper coupling portion.

2. The independent steering device of claim 1, wherein the knuckle is coupled to a vehicle wheel, and wherein the lower coupling portion passes through the center of the knuckle between the first upper coupling portion and the second upper coupling portion and is positioned at a rear side based on a virtual first plane, parallel to a rotational center shaft of the vehicle wheel.

3. The independent steering device of claim 2, wherein the virtual first plane bisects a distance between a virtual second plane that is parallel to the virtual first plane and passes through the first upper coupling portion and a virtual third plane that is parallel to the virtual first plane and passes through the second upper coupling portion.

4. The independent steering device of claim 3, wherein:
the first actuator is coupled to a first coupling point on the first upper coupling portion;
the second actuator is coupled to a second coupling point on the second upper coupling portion;
the lower connection member is coupled to a third coupling point on the lower coupling portion; and
the first coupling point is positioned on the virtual second plane, the second coupling point is positioned on the virtual third plane, and the third coupling point is positioned between the virtual second plane and the virtual third plane.

5. The independent steering device of claim 4, wherein the third coupling point is positioned between the virtual first plane and the virtual third plane.

6. The independent steering device of claim 1, wherein another end portion of the first actuator and another end portion of the second actuator are each coupled to a vehicle body.

7. The independent steering device of claim 6, further comprising:
an upper connection member connecting the second actuator and the vehicle body,
wherein the upper connection member includes a first fastening part coupled to at least a portion of the second actuator and a second fastening part extending from the first fastening part and coupled to the vehicle body.

8. The independent steering device of claim 6, wherein the lower connection member includes a third fastening part coupled to the lower coupling portion and a fourth fastening part extending from the third fastening part and coupled to the vehicle body.

9. The independent steering device of claim 1, wherein:
each of the first actuator and the second actuator includes a stroke module provided to connect the knuckle and a vehicle body;
the stroke module includes a piston coupled to the knuckle, a cylinder into which at least a portion of the piston is movably inserted, and a bracket which is coupled to the cylinder and coupled to the vehicle body; and
an inner surface of the cylinder is provided with a guide groove in a longitudinal direction of the cylinder, and an outer surface of the piston is provided with a guide protrusion provided to be inserted into the guide groove.

10. The independent steering device of claim 9, wherein:
each of the first actuator and the second actuator further includes a driving module providing driving force to linearly move the piston relative to the cylinder; and
the driving module includes a screw shaft that is rotatably disposed inside the cylinder, a screw nut that is fastened to the screw shaft to convert rotational motion of the screw shaft into linear motion of the piston, and a motor providing rotating force to the screw shaft.

11. The independent steering device of claim 10, wherein the screw nut is fixed to an inside of the piston.

12. The independent steering device of claim 11, wherein each of the piston and the screw nut is provided with an insertion hole into which a fixing pin is inserted, and wherein a coupled position of the piston and the screw nut is fixed by the fixing pin inserted into the insertion hole.

13. The independent steering device of claim 12, wherein each of the first actuator and the second actuator further includes a sensor that is coupled to the cylinder and provided to detect a relative position of the piston with respect to the cylinder, and wherein the sensor is provided to detect the fixing pin.

14. The independent steering device of claim 9, wherein an inner peripheral surface of the cylinder is provided with an air flow groove for air flow, and wherein the piston is provided with an air flow hole for exhausting air flow.

15. The independent steering device of claim 2, wherein the independent steering device is positioned within a diameter of the vehicle wheel when viewing the vehicle wheel in a direction of the rotational center shaft.

16. A vehicle, comprising:
a vehicle body;
a vehicle wheel mounted on the vehicle body; and
a steering device connecting the vehicle body and the vehicle wheel and provided to steer the vehicle wheel,
wherein the steering device includes
a knuckle coupled to the vehicle wheel and provided with a first upper coupling portion and a second upper coupling portion at an upper portion and a lower coupling portion at a lower portion,
a first actuator rotatably coupled to the first upper coupling portion,
a second actuator positioned adjacent to the first actuator and rotatably coupled to the second upper coupling portion, and
a lower connection member rotatably coupled to the lower coupling portion, and
wherein the lower coupling portion passes through a center of the knuckle between the first upper coupling portion and the second upper coupling portion and is positioned at a rear side based on a virtual first plane, parallel to a rotational center shaft of the vehicle wheel.
